(19) United States
(12) Patent Application Publication
(10) Pub. No.: US 2003/0091475 A1
(43) Pub. Date: May 15, 2003

(54) Bead trapping device

(75) Inventors: Pengguang Yu, Edmonton (CA); Kevin E. Kornelsen, Edmonton (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Micralyne Inc.

(21) Appl. No.: 10/260,704

(22) Filed: Sep. 26, 2002

Related U.S. Application Data
(60) Provisional application No. 60/325,151, filed on Sep. 26, 2001.

(51) Int. Cl. B01L 3/00; G01N 21/64

(52) U.S. Cl. 422/99; 436/169

(57) ABSTRACT

A bead trapping device for trapping beads. The device is formed from a substrate, posts extending from the substrate; the posts being patterned to form cavities between the posts, the cavities having a diameter between 0.5 μm and 200 μm; and means for loading beads onto the substrate. A method of trapping microscopic beads for analysis, the method comprising the steps of contacting a fluid containing beads with a substrate having posts extending from the substrate to form bead trapping cavities, the bead trapping cavities having a diameter between 0.5 μm and 200 μm; and loading the beads into the bead trapping cavities.

### CROSS-REFERENCE TO RELATED APPLICATION

This application claims the benefit of the filing date of U.S. Provisional Application No. 60/325,151, filed Sep. 26, 2001.

### BACKGROUND OF THE INVENTION

This application relates to the field of micro-analytical devices, particularly for use in biotechnological applications. Microscopic beads with chemically modified surfaces are used in many areas of biotechnology, such as proteomics, drug-discovery, and genomics. There is a need to lock beads into fixed positions on a test bed for application in all these areas. Some examples are DNA analysis, drug screening, and sample filtering or desalting. The invention described here is intended to produce such a device.

### SUMMARY OF THE INVENTION

There is therefore provided a bead trapping device for trapping beads. The device is formed from a substrate having posts extending from the substrate; the posts being patterned to form cavities between the posts, the cavities having a diameter between 0.5 μm and 200 μm; and means for loading beads into the cavities.

There is also provided a method of trapping microscopic beads for analysis, the method comprising the steps of contacting a fluid containing beads with a substrate having posts extending from the substrate to form bead trapping cavities, the bead trapping cavities having a diameter between 0.5 μm and 200 μm; and loading the beads into the bead trapping cavities.

The cavities may be formed in an array, such as rectangular, on a planar substrate, and preferably have uniform size. The posts may have caps, to assist in trapping beads in the cavities. A cover may be provided to trap beads in the cavities, and holes in the cover or substrate may allow fluid flow across the posts. Beads may for example be loaded into the cavities by allowing gentle settling of the beads into position under gravitational force. Beads can be guided into position using techniques such as using holes in the substrate to flow fluid through the cavities, or by magnetic or electric forces generated by devices placed adjacent the substrate, or by using a flexible substrate that is expanded to allow beads into the cavities and then contracted. Posts may be tilted to facilitate loading and unloading of the beads into and out of the cavities, and may be taller than the diameter of the cavities to permit stacking of beads. Once beads have been trapped in the cavities, a reagent may be flowed across the beads to generate reactions on the surface of the beads; and outcomes of the reactions may be detected.

These and other aspects of the invention are described in the detailed description of the invention and claimed in the claims that follow.

### BRIEF DESCRIPTION OF THE DRAWINGS

There will now be described preferred embodiments of the invention, with reference to the drawings, by way of illustration only and not with the intention of limiting the scope of the invention, in which like numerals denote like elements and in which:

FIG. 1 shows a bead trapped among posts with diamond cross section;

FIG. 2A shows a bead trapped among posts with circular cross section;

FIG. 2B shows a bead trapped among posts with caps;

FIG. 3 shows posts with a variety of post cross sections;

FIG. 4 shows a method of formation of posts using a vertical etch process, such as deep RIE;

FIG. 5 shows formation of cap at tip of post by isotropic etching after the vertical post etch;

FIGS. 6A-6E show a sequence of steps that may be carried out to load beads into cavities onto a bead trapping device

FIG. 7 shows assembly of a bead trapping device, in which holes are drilled on a bead trapping plate;

FIG. 8 shows assembly of a bead trapping device, in which holes are drilled on a cover plate;

FIG. 9 shows beads falling into cavities by magnetic force, in which the beads are made of or coated of paramagnetic material.

FIG. 10 shows beads falling into cavities by electrostatic force, in which beads carry charges;

FIGS. 11A, 11B, 11C and 11D show a through-hole in substrate helping reagent exchange and bead loading;

FIG. 12 shows bead loading with tilted posts;

FIG. 13 shows bead unloading with tilted posts.

FIGS. 14A and 14B show how a change of post height during manufacture process results in bead stacking;

FIG. 15 shows trapping beads among three posts;

FIG. 16 shows an interdigital trapping pattern;

FIGS. 17A-17D show a bead trapping device using a substrate, compressible gasket and cover plate;

FIGS. 18A and 18B show loading of beads into cavities by expansion and contraction of the cavities through bending of the substrate; and

FIGS. 19A-19D show trapping of beads by flexion of a cover for the substrate.

### DETAILED DESCRIPTION OF PREFERRED EMBODIMENTS

In this patent document, the word “comprising” is used in its non-limiting sense to mean that items following the word in the sentence are included and that items not specifically mentioned are not excluded. The use of the indefinite article “a” in the claims before an element means that one of the elements is specified, but does not specifically exclude others of the elements being present, unless the context clearly requires that there be one and only one of the elements. Where the diameter of a cavity between posts is referred to, the diameter is the diameter of the largest spherical bead that could fit in the cavity between the posts.

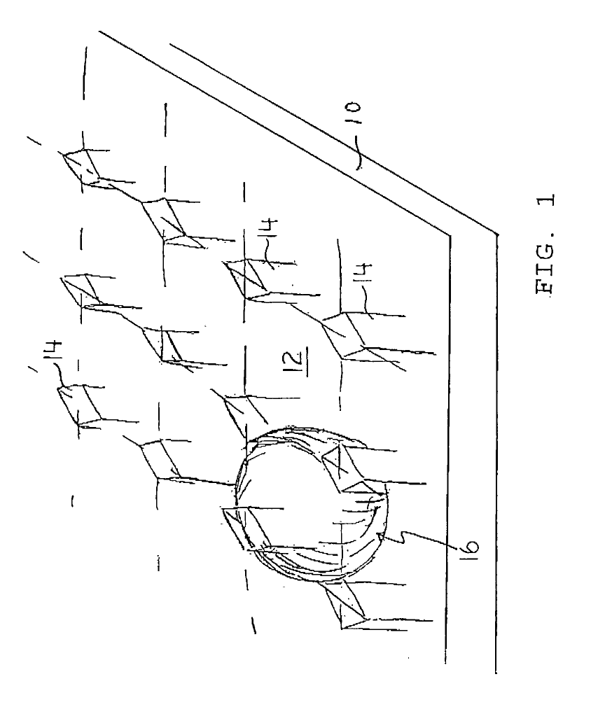

Referring to FIG. 1, an embodiment of the invention is shown in which a bead trapping device is formed from a planar substrate 10 having a surface 12. A patterned array of posts 14 is formed on the surface 12 of the substrate. Each post 14 extends away from the substrate to form a patterned array of cavities between the posts 14. The cavities have a diameter between 0.5 μm and 200 μm, and may be of uniform size as for example is produced by a rectangular array of posts 14 as shown in FIG. 1. The bead trapping device will lock beads, for example bead 16, of size between 0.5 μm and 200 μm in a specific pattern on the surface 12. The posts are preferably micromachined onto the substrate surface 12, with spacing appropriate to form cavities into which beads 16 will fit. The posts 14 surrounding the bead 16 will secure the location of the bead in the plane and may retain the bead 16 during washing or rinsing procedures. The beads 16 may be locked in place using either a cover plate over the entire device, or caps on top of the posts. The pattern and spacing of the array of posts 14 may be designed for a particular bead size and device application.

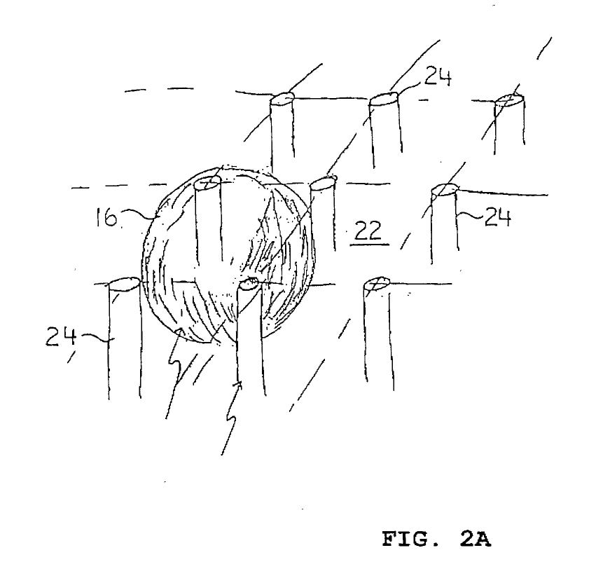

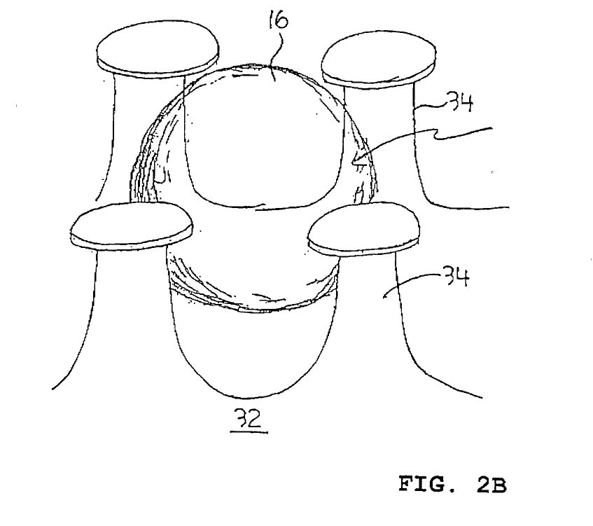

The bead trapping device is preferably fabricated on a planar substrate. The substrate material may be glass, silicon, ceramic, plastic and metal or other material suitable for the application. The post 14 typically has a height roughly equal to the diameter of the bead 16. Post cross-section includes diamond posts 14 (FIG. 1), cylindrical posts 24 on a substrate 22 (FIG. 2A) or upwardly tapering round posts 34 on a substrate 32 (FIG. 2B). Posts may be round, oval, square, diamond, square with concave or convex edges, triangular with planar, convex or concave edges, cusped or octahedral as shown in FIG. 3. More complicated post cross sections, such as “X” or “Y” shapes may also be used, particularly to give the post more strength. The foot of the posts may be sharp or round, the top may be flat or rounded, and the floor space between posts does not need to be flat. Posts with or without caps leave enough opening space at the top to let beads freely settle into the cavities.

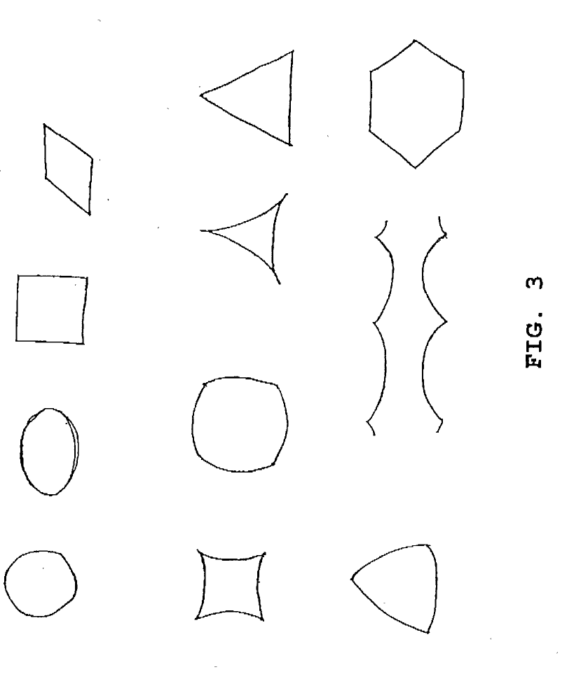

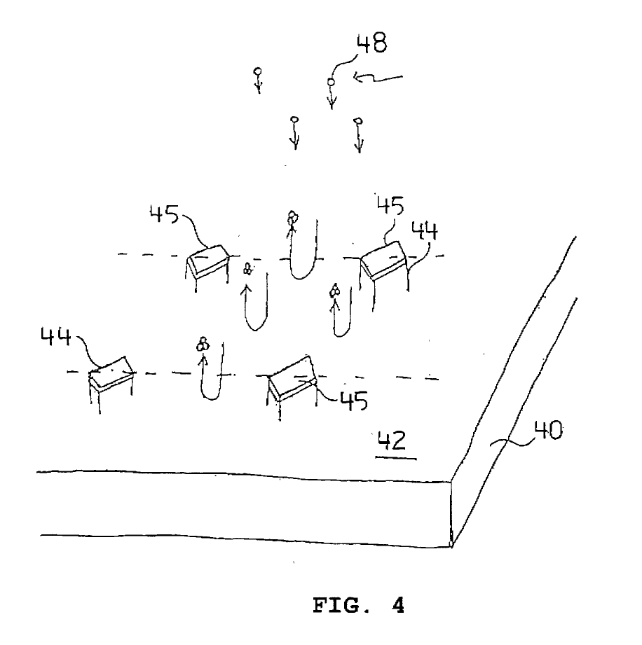

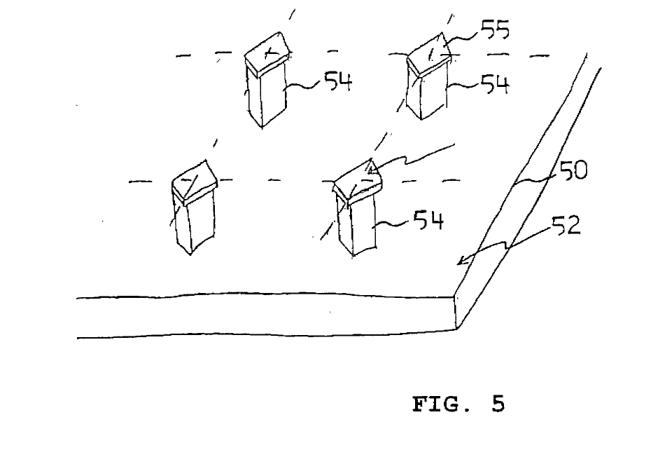

The posts 14, 24, 34 may be fabricated using microfabrication technology. As shown in FIG. 4, a method of forming posts 44 on the surface 42 of a substrate 40 comprises the steps of (1) depositing or growing masking material 45 at the surface of a substrate, (2) generating a pattern on masking material by use of lithography, (3) exposing substrate to an anisotropic etchant using active ions 48, (typically a process such an RIE (reactive ion etching) or Deep-RIE), to etch the substrate. The regions of the substrate that are etched away become the cavities. Additional embodiments of the method steps include (4) tilting the substrate in a desired direction to form non-vertical posts or columns, and (5) exposing substrate 50 subsequently to specific etchant to continue isotropic etching of a post 54 extending from surface 52 and, initially made as shown in FIG. 4, to form a cap 55 at the tip of an undercut post 54 as shown in FIG. 5. As illustrated in FIG. 5, the cap 55 on the top of each post 54 may be used as an aid in trapping the beads. In this design, the cap 55 may be made of a flexible material with diameter such that a small force is required to push a bead past the cap 55 and into the cavity. Alternatively, the cap 55 may be stiff and allow free movement of a bead into the cavity, but the presence of the cap reduces the probability of beads escaping from the cavity. The cap may be made of either a rigid or flexible material, such as metal, SiO₂, Si₃N₄, polymer or combined materials. The posts should be made with sufficient strength for the intended application. A suitable post dimension would be greater than 1 μm in the smallest cross-section dimension.

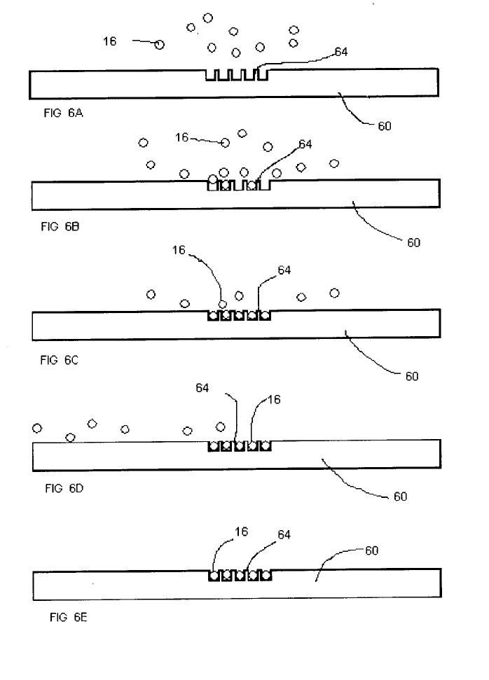

Bead loading is illustrated in FIGS. 6A-6E. FIG. 6A shows a substrate 60 with micromachined posts 64 extending from the substrate 60. Fluid 63 containing beads 16 is in contact with the posts 64. Under the influence of a loading force, the beads settle into the cavities between the posts 64 as illustrated in FIGS. 6B and 6C. In FIG. 6D, the cavities are fully loaded with beads 16. In FIG. 6E, the cavities in the substrate 60 are completely filled with beads and excess beads are washed away by fluid flow across the surface of the substrate 60.

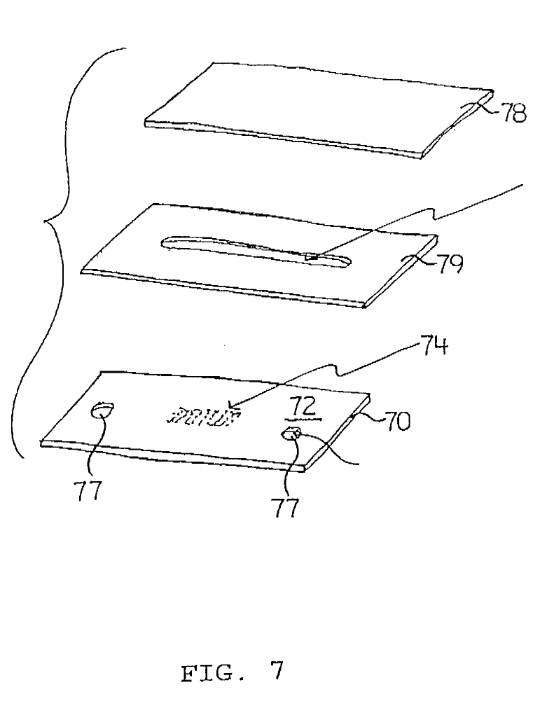

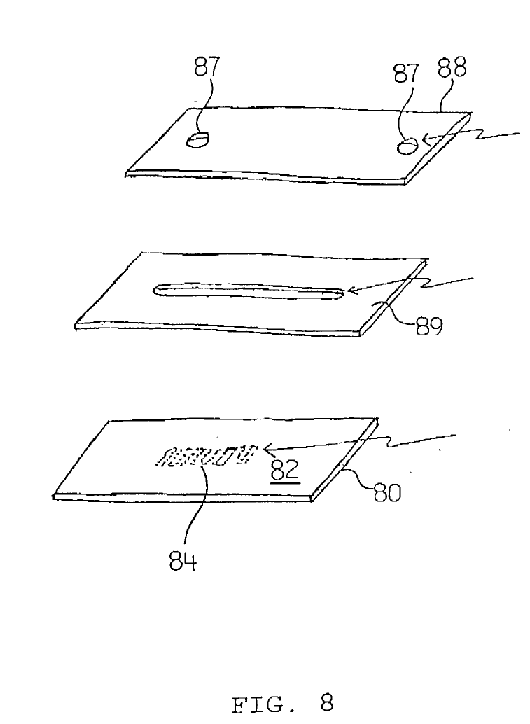

Exploded views of bead trapping devices are shown in FIGS. 7 and 8, where an array of posts 74, 84 are formed on a surface 72, 82 of a planar substrate 70, 80. Microscopic beads may be loaded by settling from a liquid solution in contact with the surfaces 72, 82. The fluid may be constrained using a cover plate 78, 88 which may have fluid inlet and outlet holes 77 in the substrate 72 (FIG. 7) or holes 87 in the cover 88 (FIG. 8), and a gasket 79, 89 thicker than the bead diameter.

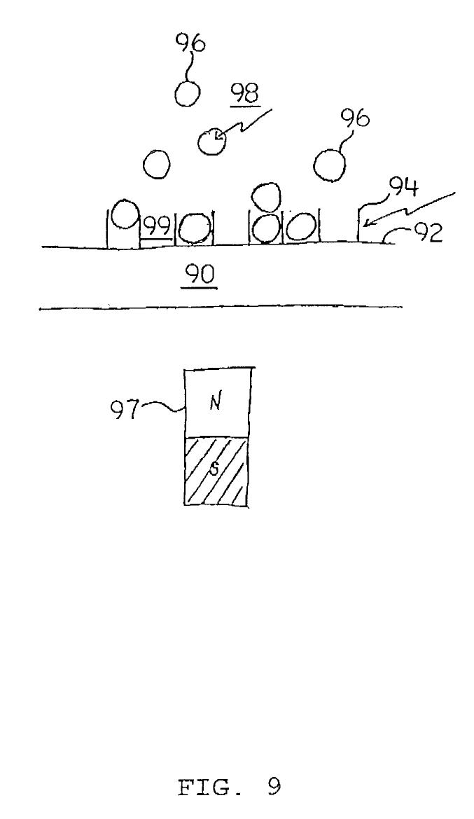

The beads 16 may be loaded into the cavities by any one or more of various means. For example, beads 16 may be loaded into the cavities by forces such as gravitational, magnetic, electrostatic, electrophoretic, dielectrophoretic, thermal, convection, fluid drag forces, centrifugal, or settling during fluid evaporation. For example, in FIG. 9, a magnet 97 or other magnetic field source disposed adjacent substrate 90 acts on paramagnetic beads 96 in a solution 97 to force them into cavities 99 between posts 94 on surface 92 on substrate 90. In FIG. 10, a pair of electrodes 108 connected to a power supply 109 or other electric field source disposed adjacent substrate 100 creates an electric field that acts on charged beads 106 in a bead solution 107 to force the beads 106 into cavities between posts 104 on surface 102 of substrate 100. The electric field may be DC in which case the beads move by electrostatic forces, or AC in which case the beads move by dielectrophoretic forces. Another way to load beads into the cavities is to use a stretchable or flexible substrate. A stretchable substrate is first provided with posts defining cavities. Fluid containing beads is contacted with the posts. The substrate is stretched or bulged outwards to open the cavities larger than the beads. Once beads are loaded into the cavities, by any of various forces including by diffusion, the substrate is then allowed to contract to trap the beads in the cavities. The stretching may occur along any axis of the cavities, such as lateral stretching in one or two dimensions, or cylindrical or spherical stretching by inflation of the substrate.

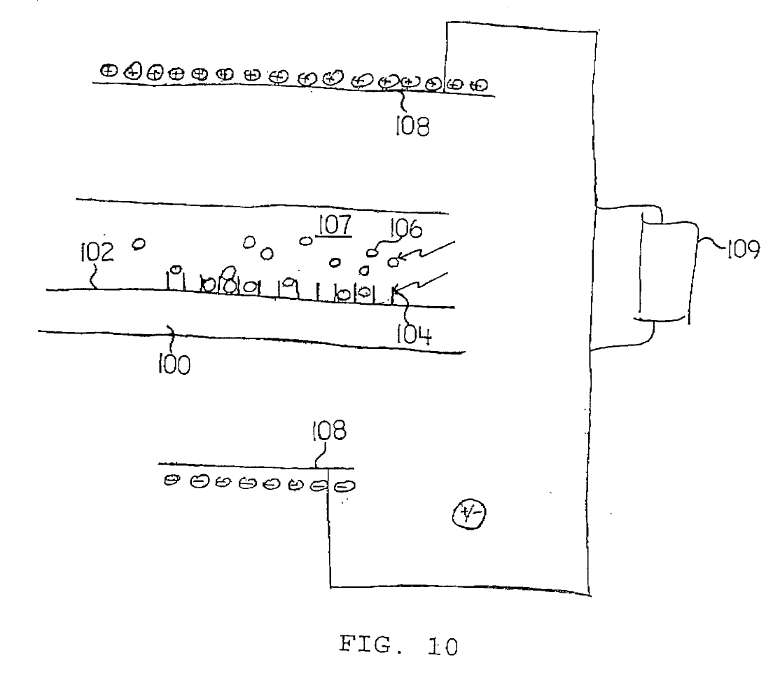

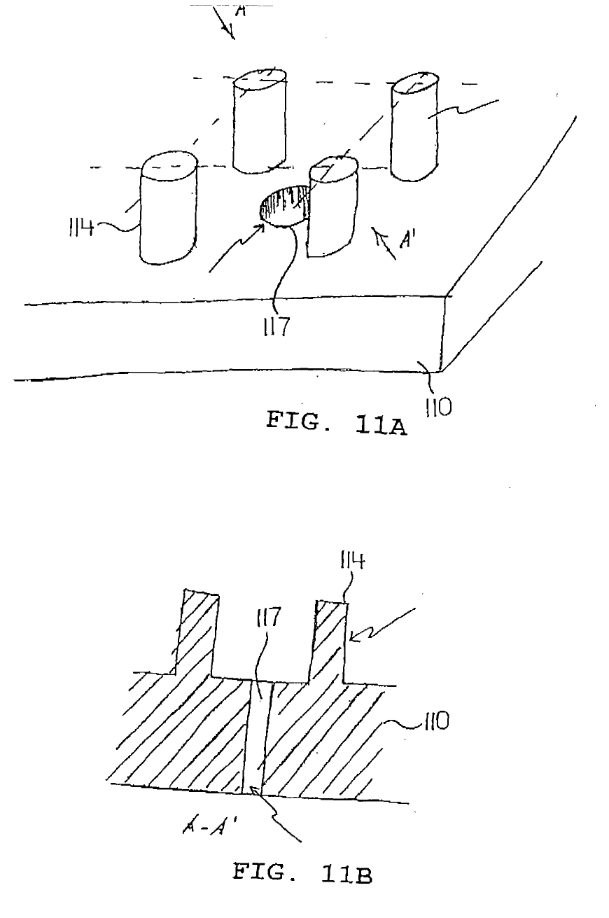

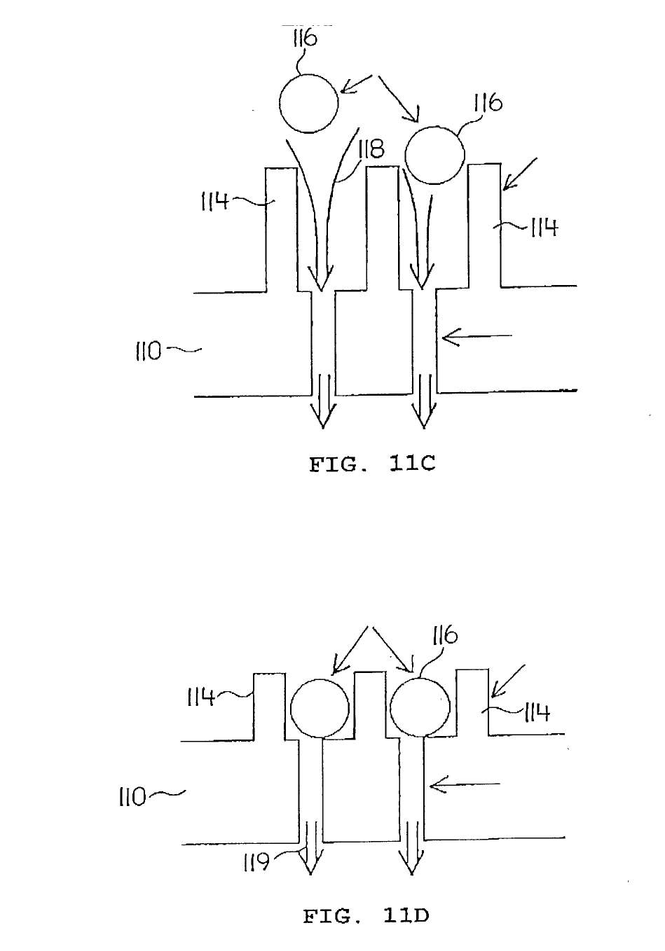

As shown in FIG. 11A, 11B, a substrate 110 with posts 114 may be provided with fluid egress holes 117 at the bottom of each cavity between posts 114. As shown in FIGS. 11C and 11D, a flow of fluid 118, 119 is created by suitable pumps through the holes 117. Drag forces from the fluid acting on the beads 116 draw the beads 116 into the cavities. Movement of the fluid may be controlled by external mechanical pumps, integrated microfabricated pumps, electrophoretic force on the fluid, or centrifugal force on the fluid. After filling the cavities on the substrate 110 with beads 116, excess beads 116 will stay on top of the posts 114 and may be flushed away.

Many types of beads are commercially manufactured and may be used with the bead trapping device. They are roughly spherical in shape and are typically made using materials such as plastic, ceramic, glass, or metal. Beads may be solid or porous. Size and shape uniformity of the beads will be an important factor in the performance of the trapping plate. It is preferred that the beads have a uniform size and be close to spherical.

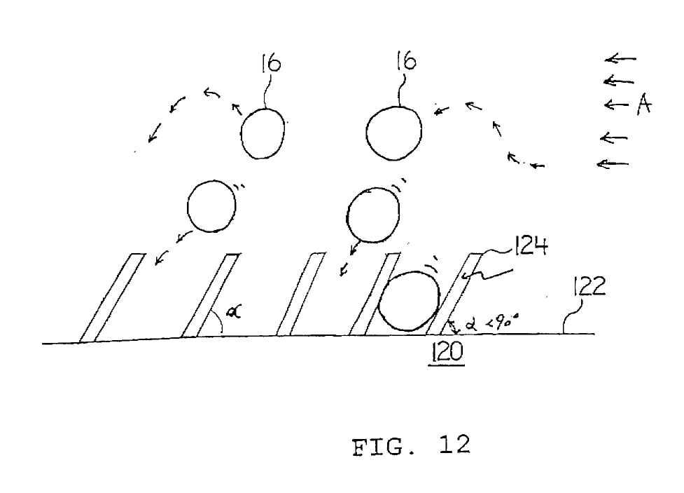

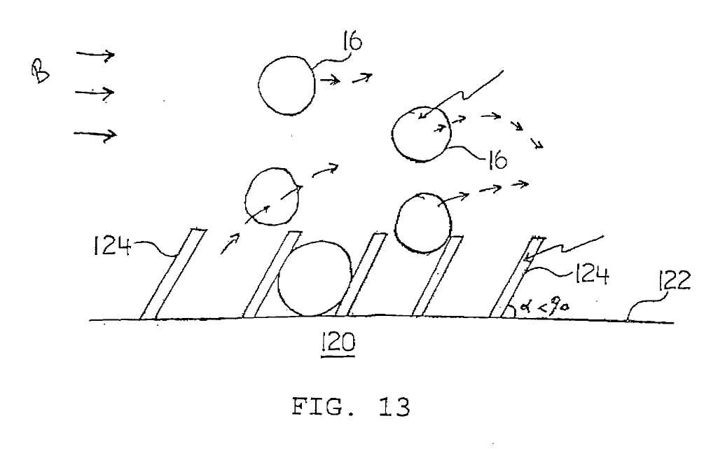

Tilting the posts may aid in trapping the beads from a flowing solution. As shown in FIGS. 12 and 13, posts 124 may be tilted at an angle α to the substrate surface 122. In FIG. 12, a bead carrying solution flowing in direction A draws the beads 16 across the posts 124. Preferably, direction A is opposite to the direction in which α is a maximum. Any suitable force may be used to direct the beads 16 downward onto the surface 122 and into the cavities between the posts 124 to load the beads 16 on the substrate 120. Reversing the fluid flow to direction B shown in FIG. 13 enables unloading of the beads 16 from the substrate 120.

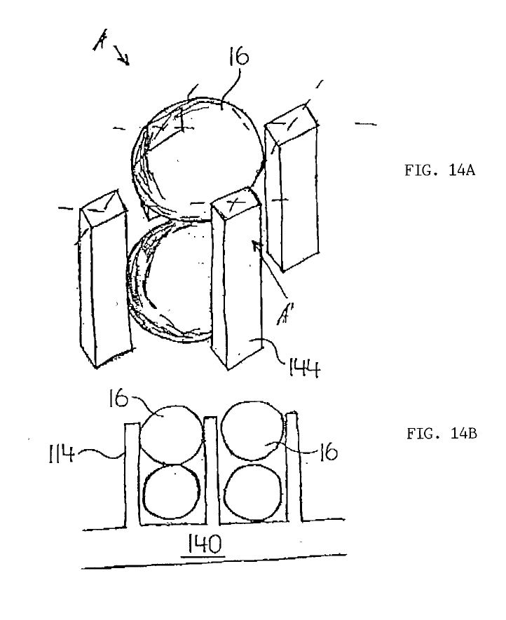

As shown in FIGS. 14A, 14B, an additional variation of the design is to make the posts 144 on substrate 140 taller than the diameter of a single bead 16. This allows trapping of beads in columns with several beads 16 stacked at each cavity or bead trapping location.

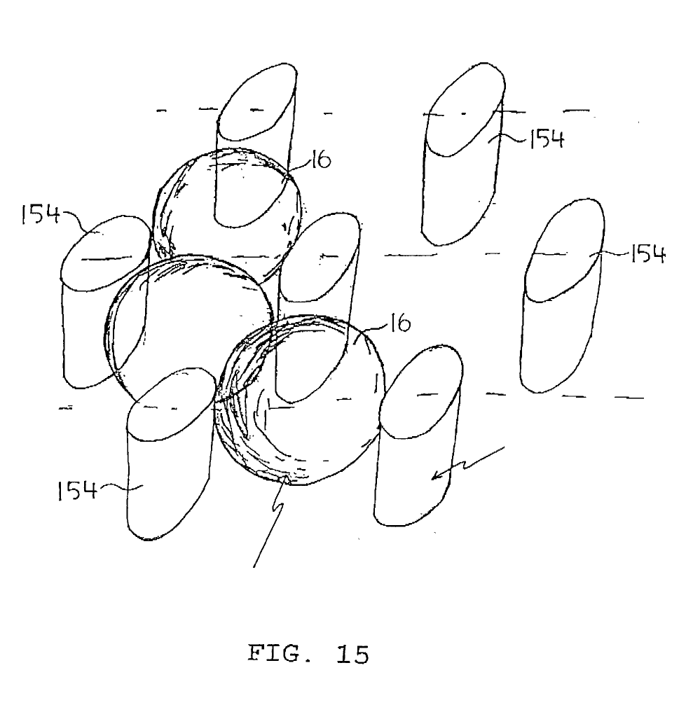

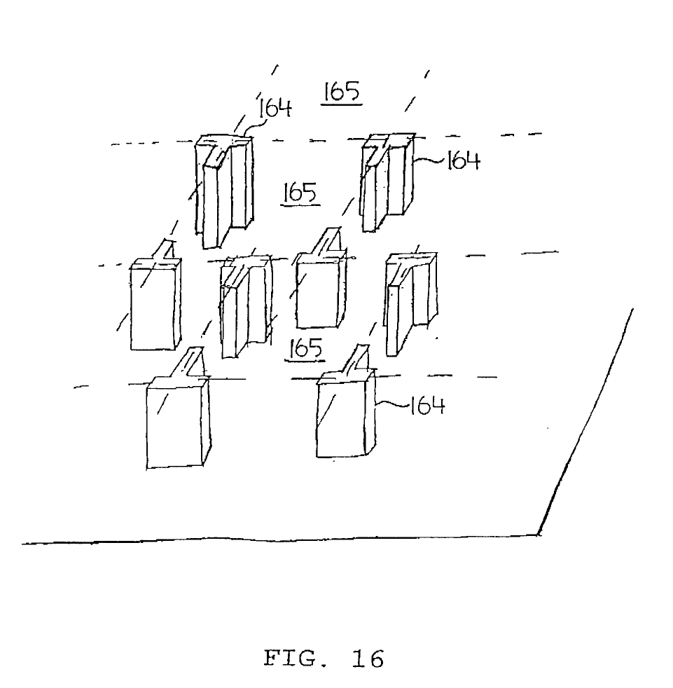

As shown in FIG. 15, posts 154 may be arranged in an array such that three posts 154 trap each bead 16. As shown in FIG. 16, posts 164 may have T-shaped cross-sections, and may be arranged such that the cavities 165 form an irregular pattern. Adjacent posts 164 may also be connected to form more complex shapes.

One advantage of this bead-trapping design is the way fluid is able to flow freely around the sides of the beads 16. This is enhanced by minimizing the cross-sectional areas of the posts 14. This characteristic has advantages in applications where some interaction between the bead surface and a fluid flowing past the beads is desired.

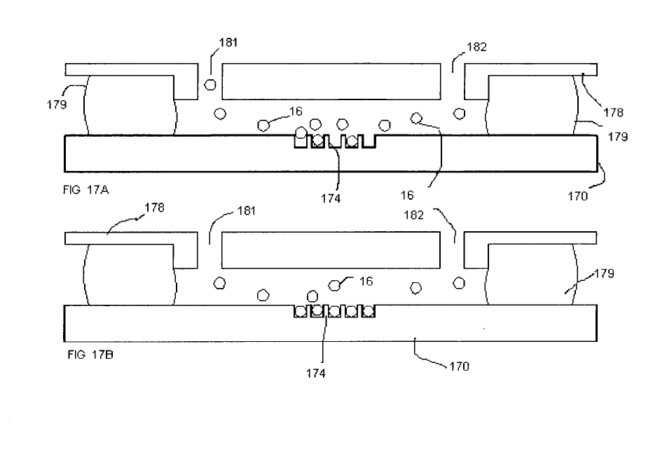

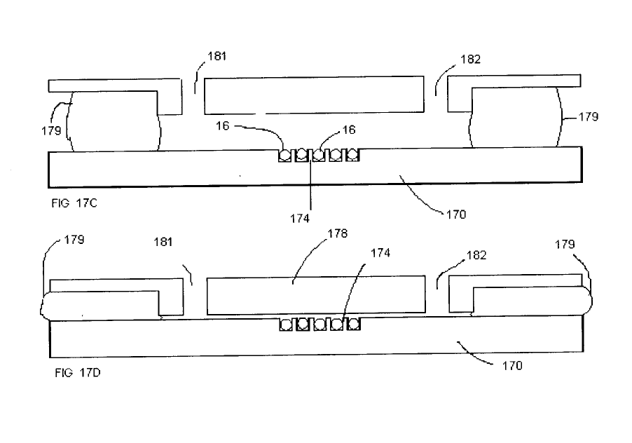

Referring to FIGS. 17A, 17B, 17c, 17D, using a compressible gasket, it is possible to adjust the position a cover plate for both loading and then locking the beads in place. In FIGS. 17A-17D, substrate 170 has posts 174 machined in it to form bead trapping cavities between the posts 174. A cover 178 is provided for the substrate 170 and spaced from the substrate 170 by gasket 179. Openings or ports 181, 182 are provided to allow a fluid to enter and exit the volume between the substrate 170 and cover 178. In FIG. 17A, a fluid containing beads 16 is brought into contact with the cavities defined by the posts 174 to allow loading of the beads 16 into the cavities by suitable forces. For loading, the gasket 179 will be partially compressed, to allow movement of beads through the gap between the cover plate 179 and the substrate or post plate 170. After a suitable time, the cavities will become filled with the beads 16 (FIG. 17B). Fluid containing beads 16 may then be flushed from the gap between the cover 178 and substrate 170 (FIG. 17C). For locking as shown in FIG. 17D, the gasket 179 will be further compressed to reduce the gap to the point where beads 16 cannot escape from the cavities. Compression of the gasket 179 may be provided by any suitable means. The gasket may be made from any compressible material, such as rubber or silicone.

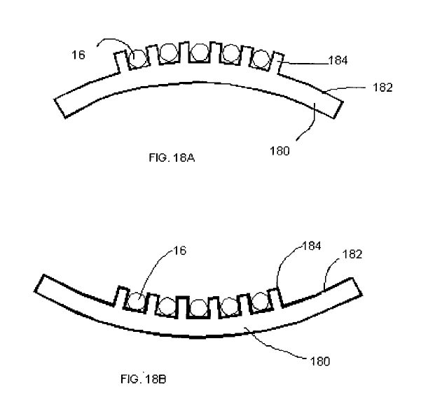

Loading of the beads into the cavities and locking them in place may be accomplished using bending of the substrate as illustrated in FIGS. 18A and 18B. In FIG. 18A, substrate 180 is bent with posts 184 extending from the convex expanding surface 182 of the substrate 180. Upon bending of the substrate 180, the cavities enlarge to receive beads 16. As shown in FIG. 18B, bending of the substrate 180 in the opposite direction, towards making the surface 182 less convex, flat or concave, compresses the cavities and traps the beads 16 in the cavities.

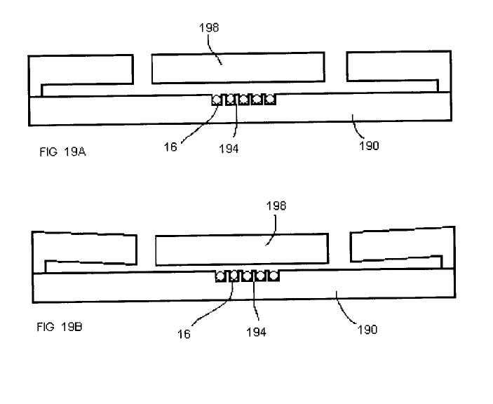

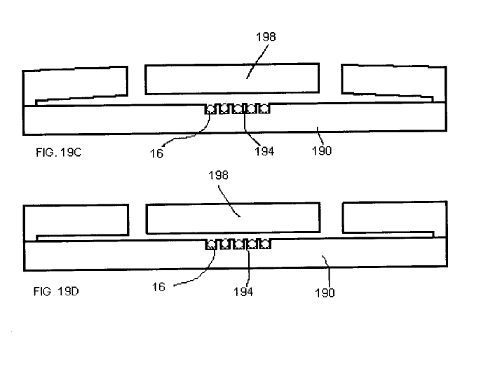

The gap between the post and cover plates may be altered by bending the plates using an external force generated by any suitable means as illustrated in FIGS. 19A and 19B. In FIG. 19A, substrate 190 with posts 194 has beads 16 that have been introduced to the gap between cover plate 198 and loaded into the cavities between the posts 194. When the cover plate 198 and base plate or substrate 190 are forced together as illustrated in FIG. 19B to a gap size less than the bead diameter, the beads 16 are prevented from escaping from the cavities.

As illustrated in FIGS. 19C and 19D, pressure of fluid in the gap between the cover plate 198 and post plate 190 increases the gap between the plates 190, 198 and allows bead loading. Pressurization of the fluid in the gap may be obtained by any of various means. When pressure on the fluid in the gap is released, the gap closes (FIG. 19D) and the beads 16 are trapped in place.

The bead trapping device has use for trapping microscopic beads with chemically modified surfaces as used in many areas of bio-technology, such as proteomics, drug-discovery, and genomics. The ability to lock beads into fixed positions on a test bed has applications in all these areas. Some examples are DNA analysis, drug screening, and sample filtering or desalting.

One application is to fill the plate with beads 16 having many different characteristics. A reagent flowing through the bead array will react with the different beads in different ways. Probing the outcome of the interactions with all the different types of beads gives a large amount of information in a short time. Interaction outcomes may be determined using techniques such as optical characterization, fluorescence, or electrochemical techniques. Another analysis option is to draw sample off the bead surface through a hole in the substrate beneath the bead, and then analyze the sample with external instrumentation such as mass-spectrometry.

A person skilled in the art could make immaterial modifications to the invention described in this patent document without departing from the essence of the invention.

What is claimed is:

1. A bead trapping device, comprising:
a substrate;
posts extending from the substrate;
the posts being patterned to form cavities between the posts, the cavities having a diameter between 0.5 μm and 200 μm; and
means for loading beads into the cavities.

2. The bead trapping device of claim 1 in which the cavities have uniform size.

3. The bead trapping device of claim 1 in which the posts form an array of posts.

4. The bead trapping device of claim 3 in which the array is a rectangular array.

5. The bead trapping device of claim 1 in which the posts have caps.

6. The bead trapping device of claim 5 in which the caps are made of flexible material.

7. The bead trapping device of claim 5 in which the caps are made of rigid material.

8. The bead trapping device of claim 1 in which the substrate has a planar surface.

9. The bead trapping device of claim 1 in which the substrate is provided with a cover.

10. The bead trapping device of claim 9 in which the means for loading beads into the cavities comprises holes in the cover to permit fluid flow through the holes and across the posts.

11. The bead trapping device of claim 9 in which the means for loading beads into the cavities comprises holes in the substrate to permit fluid flow through the holes and across the posts.

12. The bead trapping device of claim 1 in which the means for loading beads into the cavities comprises a magnetic field source.

13. The bead trapping device of claim 1 in which the means for loading beads into the cavities comprises an electric field source.

14. The bead trapping device of claim 1 in which the means for loading beads into the cavities comprises the substrate being provided with fluid egress holes extending through the substrate and communicating with the cavities.

15. The bead trapping device of claim 14 in which the substrate is provided with a fluid egress hole for each cavity.

16. The bead trapping device of claim 1 in which the posts are tilted.

17. The bead trapping device of claim 1 in which the posts are taller than the diameter of the cavities.

18. The bead trapping device of claim 17 in which the height of the posts is twice the diameter of the cavities.

19. The bead trapping device of claim 1 in which the posts are arranged such that each cavity is defined by three posts.

20. The bead trapping device of claim 1 in which the posts form an irregular array.

21. The bead trapping device of claim 1 in which the loaded beads are locked in place by a cover plate.

22. A method of trapping microscopic beads for analysis, the method comprising the steps of:
contacting a fluid containing beads with a substrate having posts extending from the substrate to form bead trapping cavities, the bead trapping cavities having a diameter between 0.5 μm and 200 μm; and
loading the beads into the bead trapping cavities.

23. The method of claim 22 in which the posts have caps, and the beads are directed into the cavities past the caps, whereby the caps act to constrain the beads within the cavities.

24. The method of claim 22 in which the beads are loaded into the bead trapping cavities by flowing fluid through the bead trapping cavities to draw beads into the bead trapping cavities.

25. The method of claim 22 in which the beads are loaded into the bead trapping cavities by action of a magnetic field.

26. The method of claim 22 in which the beads are loaded into the bead trapping cavities by action of an electric field.

27. The method of claim 22 in which the posts are tilted against fluid flow for loading the bead trapping cavities.

28. The method of claim 27 further comprising the step of reversing fluid flow to unload the beads from the bead trapping cavities.

29. The method of claim 22 in which the beads are stacked in the bead trapping cavities.

30. The method of claim 22 further comprising the step of locking the beads in the bead trapping cavities.

31. The method of claim 30 in which locking the beads comprises locking the beads with a cover plate.

32. The method of claim 31 in which the cover plate is separated from the substrate with a compressible gasket.

33. The method of claim 22 in which loading the beads into the cavities comprises stretching the substrate to open the cavities to receive beads and then closing the cavities.

34. A method of analysis, comprising the steps of:
trapping microscopic beads for analysis, by contacting a fluid containing beads with a substrate having posts extending from the substrate to form bead trapping cavities, the bead trapping cavities having a diameter between 0.5 μm and 200 μm, the beads being loaded into the bead trapping cavities;
flowing a reagent across the beads to generate reactions on the surface of the beads; and
detecting outcomes of the reactions.
